(19) United States
(12) Patent Application Publication
(10) Pub. No.: US 2003/0142817 A1
(43) Pub. Date: Jul. 31, 2003

(54) Earphone cable-receiving device with power recharge function

(76) Inventor: Sheng Hsin Liao, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/059,297

(22) Filed: Jan. 31, 2002

(51) Int. Cl. H04M 1/00; H04M 9/00

(52) U.S. Cl. 379/428.01

(57) ABSTRACT

An earphone cable-receiving device includes a cable-receiving structure and a power recharge unit. The cable-receiving structure includes an outer case, a cable-winding plate, a communication cable, and a spiral spring. The cable-winding plate and the spiral spring, connected to each other, are further received within the outer case. The communication cable is wound on the cable-winding plate, and further has an external terminal mounted with a first connector that can removably connect an earphone. The power recharge unit is mounted into the outer case and is further connected to the communication cable. The power recharge unit is further connected to a second connector via a transmission cable to recharge a portable electrical device connected to the second connector. Thereby, various types of power sources can be connected to the earphone cable-receiving device to recharge the portable electrical device.

### BACKGROUND OF THE INVENTION

1. Field of the Invention

The invention relates to an earphone cable-receiving device with power recharge function. More particularly, the invention provides an earphone cable-receiving device with power recharge function that can recharge a portable electrical device from various types of power sources such as portable computers, power recharge terminals of automobile, or dry battery.

2. Description of the Related Art

As electrical and telecommunication appliances become popular, communication cables are increasingly present in our environment to connect various types of devices. To prevent too long and numerous communication cables from being interlaced or knotted with one another or, on the contrary, to avoid too short communication cables incompatible with a practical use, The cable-receiving structures for communication devices been developed various types. The cable-receiving structures of the prior art are similarly based on a principal structure that includes an outer case, a communication cable, a cable-winding plate, and a spiral spring. Via a cable-receiving case as disclosed above, the conventional communication cable, via a connector mounted on a terminal thereof, can connect a communication device.

Because the spring elements of the traditional cable-receiving structures exert a substantial retraction tension on the communication cables pulled out, the communication cables therefore usually cannot be outwardly held in a stable manner. A utilization of the communication cables can be thereby substantially impeded. To overcome the above problems, the cable-receiving structures been disclosed various types. The structures disclosed in the above applications principally use the engagement of a flexibly oscillating member into blocking notches defined on the S cable-winding plate to perform winding or immobilizing of the pulled-out communication cable.

On the other hand, as the developments of electronic industries emphasize on the miniaturization of electronic appliances, portable electrical devices such as portable computers, mobile phones, or personal digital assistant (PDA) are increasingly popular. To be conveniently operable, those portable electrical devices are usually provided with rechargeable batteries (such as lithium ion batteries, nickel metal hydride batteries, or nickel cadmium batteries) that need regular recharges via a power recharge device.

As briefly described above, the conventional cable-receiving cases are strictly provided with cable-winding/retraction function and are not capable of recharging batteries. Furthermore, the traditional power recharge devices are usually capable of performing a simple type of recharging operation, which thus renders their fields of utilization substantially limited. As a result, the use of traditional cable-receiving cases and power recharge devices thus presents various inconveniences that may be improved.

### SUMMARY OF THE INVENTION

It is therefore a principal object of the invention to provide an earphone cable-receiving device with power recharge function that is provided with earphone cable-receiving function while further being capable of recharging a portable electrical device from various types of power sources.

To accomplish the above and other objectives, an earphone cable-receiving device with power recharge function is provided. The earphone cable-receiving device comprises a cable-receiving structure and a power recharge unit. The cable-receiving structure comprises an outer case, a cable-winding plate, a communication cable, and a spiral spring. The cable-winding plate and the spiral spring are connected to each other, and are further received within the outer case. The communication cable is wound on the cable-winding plate, and further has an external terminal mounted with a first connector that can removably connect an earphone. The power recharge unit is mounted into the outer case and is further connected to the communication cable. The power recharge unit is further connected to a second connector via a transmission cable to recharge a portable electrical device connected to the second connector.

With the above earphone cable-receiving device, the first connector can be removably connected to a power source while the second connector is connected to a portable electrical device. Via the power recharge unit, the portable electrical device can be thereby recharged. With the possibility of connecting various types of power sources, the recharge of the portable electrical device via the earphone cable-receiving device further can be convenient and user-friendly.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of an earphone cable-receiving device with power recharge function according to a first embodiment of the invention; FIG. 2 is an exploded view of an earphone cable-receiving device with power recharge function according to the first embodiment of the invention;

FIG. 3 is a section view of an earphone cable-receiving device with power recharge function according to the first embodiment of the invention;

FIG. 4 and FIG. 5 are perspective views illustrating various configurations of use of the earphone cable-receiving device with power recharge function according to the first embodiment of the invention;

FIG. 6 is a perspective view of an earphone cable-receiving device with power recharge function according to a second embodiment of the invention;

FIG. 7 is a perspective view of an earphone cable-receiving device with power recharge function according to a third embodiment of the invention;

FIG. 8 is a perspective view illustrating a configuration of use of the earphone cable-receiving device with power recharge function according to the third embodiment of the invention;

FIG. 9 is an exploded view of an earphone cable-receiving device with power recharge function according to a fourth embodiment of the invention; and

FIG. 10 is a perspective view of an earphone cable-receiving device with power recharge function according to a fifth embodiment of the invention.

### DETAILED DESCRIPTION OF THE EMBODIMENTS

Wherever possible in the following description, like reference numerals will refer to like elements and parts unless otherwise illustrated.

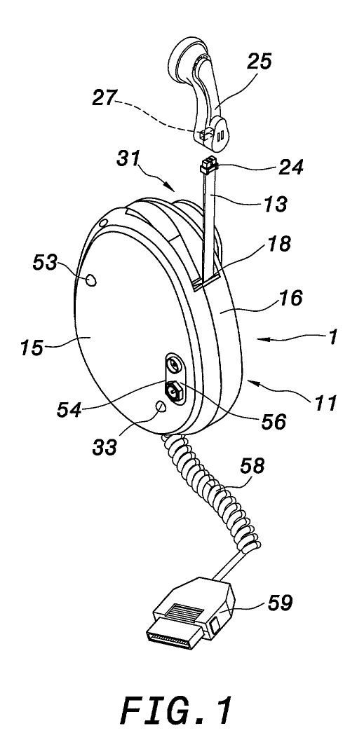

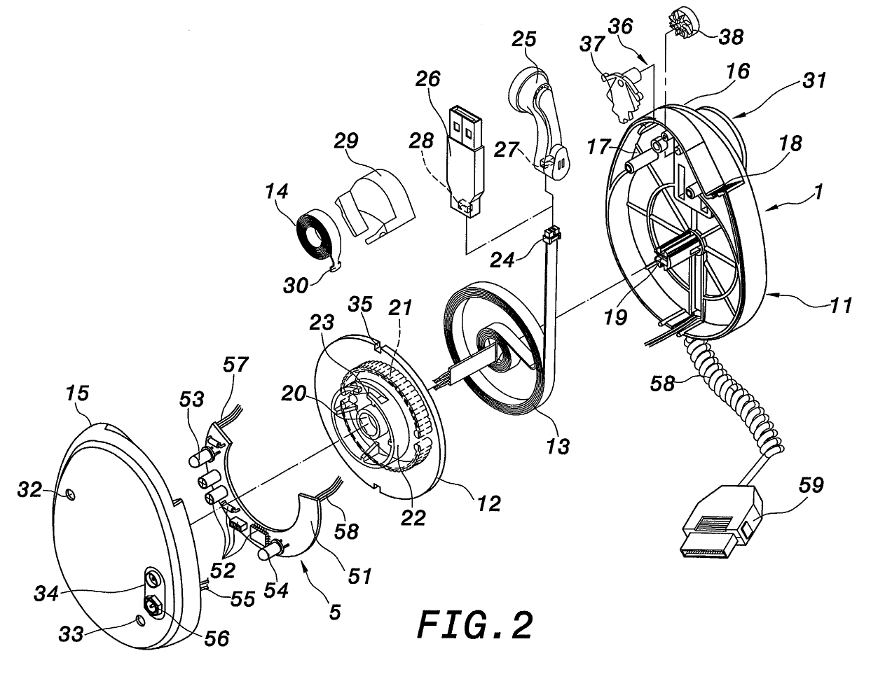

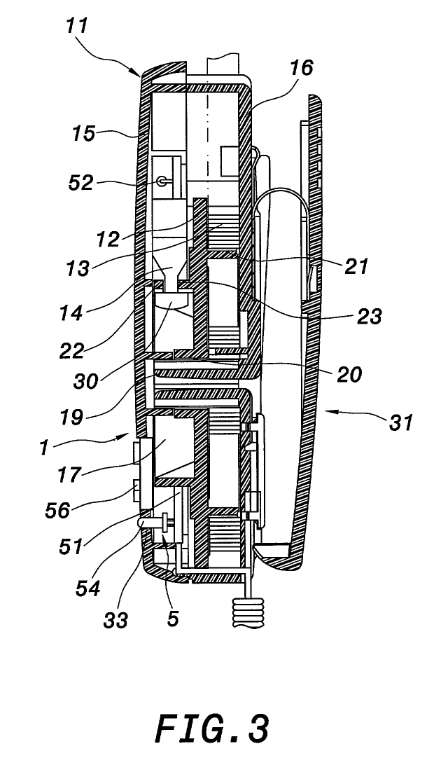

Referring to FIG. 1 through FIG. 3, various views schematically illustrate an earphone cable-receiving device with power recharge function according to a first embodiment of the invention. The earphone cable-receiving device comprises a cable-receiving structure 1 and a power recharge unit 5. The cable-receiving structure 1 may be formed into any adequate shape according to specific design choices. In this embodiment, the cable-receiving structure 1 comprises an outer case 11, a cable-winding plate 12, a communication cable 13, and a spiral spring 14. The outer case 11 is included an upper case 15 and a lower case 16 that are assembled with each other via fastening engagement or screw assembly to define an hollow space. A cable-receiving cavity 17 is thereby defined within the outer case 11 to receive the communication cable 13. A cable hole 18 is further adequately defined through a sidewall of the cable-receiving cavity 17 to enable the communication cable 13 received to extend externally. An shaft 19 further projects from a central location of the cable-receiving cavity 17. Furthermore, a clamp 31 is connected to the out surface of the outer case 11 to allow the user to conveniently fasten the earphone cable-receiving device to a belt or other external elements.

The cable-winding plate 12 is formed in a disk shape and is defined portion shaft hole 20 thereof. Two opposite surfaces of the cable-winding plate 12 with a cable-winding ring 21 and a spring fastening member 22 thereon, respectively, a fastener slot 23 being further defined in the spring fastening seat 22. The cable-winding plate 12 is received in the cable-receiving cavity 17 of the outer case 11 via the shaft hole 20 is connected pivotally to the shaft 19. The cable-winding plate 12 can thereby rotate within the cable-receiving cavity 17.

The communication cable 13 is received within the cable-receiving cavity 17 of the outer case 11 via the communication cable 13 being winded around the cable-winding plate 21 and the shaft 19 of the cable-winding plate 12. The communication cable 13 is a 4-wires cable and have two ends. The one end communication cable 13 connected to a first connector 24 and outwardly extends through the cable hole 18 of the outer case 11. The first connector 24 thereby can connect either an earphone 25 or a fifth connector 26. The other end of the communication cable 13 passes through the shaft hole 20 to the opposite surface of the cable-receiving plate 12 to connect the power recharge unit 5.

the earphone 25 has a third connector 27 and connects to the first connector 24. The earphone 25 can be thereby separately connected to the communication cable 13. The fifth connector 26 is a Universal Serial Bus (USB) connector which connects to the fourth connector 28 which is opposite the first connector 24. The user can choose whether the earphone 25 or the fifth connector 26 connects to the end of the communication cable 13 via connecting to the fourth connector 28.

The spiral spring 14 is positioned within the cable-receiving cavity 17 of the outer case 11 via a support member 29. An attachment end 30 of the spiral spring 14 is further securely fastened into the fastener slot 23 of the spring fastening seat 22. The spiral spring 14 is thereby connected to the cable-winding plate 12 via the spring fastening seat 22. When the cable-winding plate 12 rotates, resilient force is thus accumulated to resiliently retract the communication cable 13 wound on the cable-winding plate 12.

The power recharge unit 5, placed within the outer case 11, comprises a circuit board 51 and a plurality of electrical elements 52 and indicator lamps 53, 54 placed on the circuit board 51. The indicator lamps 53, 54 may be, for example, light-emitting diodes (LED) or lighting bulbs that can flicker for indication of operating configuration. The indicator lamps 53, 54 may be also used as illumination or warning lamps. Light grooves 32, 33 are further defined through the outer case 11 vis-a-vis the indicator lamps 53, 54, lights from the indicator lamps 53, 54 are thereby externally visible. The circuit board 51 is further connected to a battery-connecting seat 56 via connection wires 55. The battery-connecting seat 56 is mounted into a mounting opening 34 therefor defined through the outer case 11. The circuit board 51 is electrically connected to the second terminal of the communication cable 13 via a transmission cable 57, wherein the second terminal of the communication cable 13 is constituted of two two-interlaced wires. It would be readily appreciated that the second terminal of the communication cable 13 can be alternatively directly connected to the circuit board 51. The circuit board 51 is further electrically connected to a second connector 59 via a second transmission cable 58.

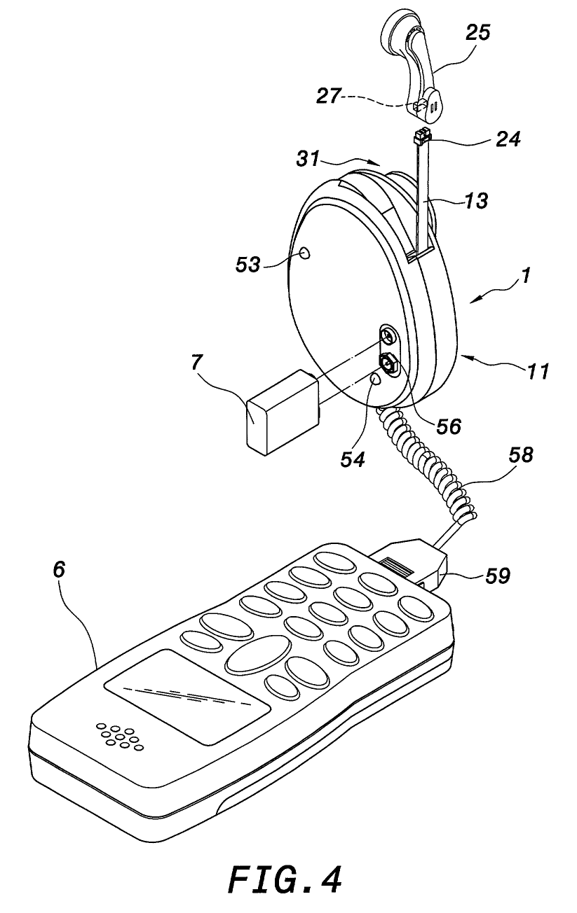

As shown in FIG. 4, an earphone cable-receiving device with power recharge function is hence achieved. In practical use, the cable-receiving structure 1 receives by winding a substantially long communication cable 13, and further provides retraction function of the communication cable 13. The user can externally connect the second connector by engagement into a first portable electrical device 6 such as a mobile phone. Furthermore, as the earphone 25, being connected to the external terminal of the communication cable 13, is extended out of the cable-receiving device 1 via pulling, a retraction tension is maintained in the communication cable 13. As a result, when it is released, the communication cable 13 is conveniently retracted and wound into the cable-receiving device 1. Therefore, inadvertent interlaces and knots of the outer portion of the communication cable 13 are prevented. Because the cable-receiving structure 1 can receive a substantially long communication cable 13, the accessibility thereof is therefore improved.

As shown in FIG. 4, conventional dry battery 7 can be electrically connected to the battery-connecting seat 56 to supply the power recharge unit 5 with adequate power for recharging the portable electrical device 6. This type of power recharge may be particularly convenient in travelling conditions.

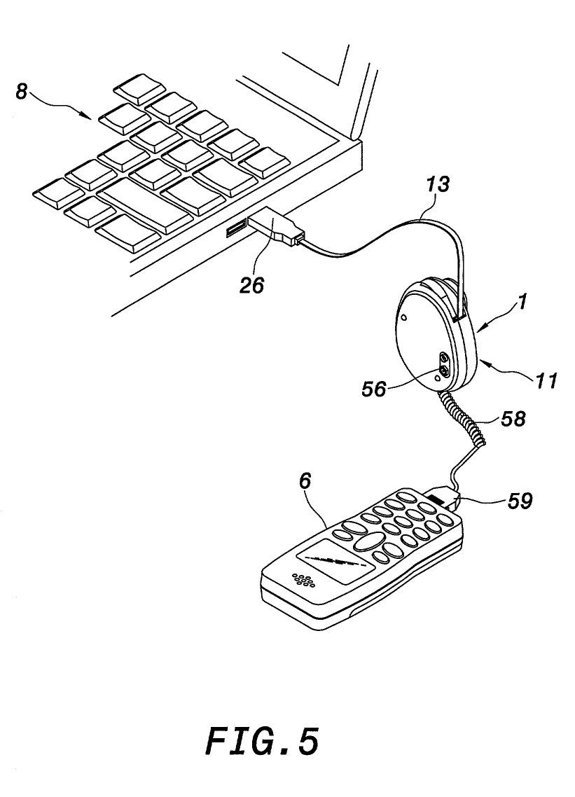

As shown in FIG. 5, the fifth connector 26, connected to the communication cable 13, can be further electrically connected to a direct current output of a second portable electrical device 8 such as a portable computer, for example. The second portable electrical device 8 thereby supplies the power recharge unit 5 with adequate power for recharging the first portable electrical device 6 that may be, for example, a mobile phone.

As described above, the earphone cable-receiving device of the invention can therefore advantageously provide power recharge function. With the possibility of connecting various types of power sources, such as portable computer, internal recharge terminal of automobile (see description hereafter), or dry battery, the earphone cable-receiving device of the invention can thus provide a flexible recharge adaptable to different situations. The use of the invention is therefore greatly convenient and user-friendly.

In order to prevent a disturbance caused by the retraction tension exerted on the pulled-out communication cable 13, a blocking notch 35 may be defined on the cable-winding plate 12, and a back-and-forth controller device 36 may be further mounted proximate to the cable-winding plate 12 to engage the notch 37. The back-and-forth controller device 36 comprises an oscillating member 37 that can freely oscillate, and a ratch 38 that can freely rotate. By means of the engagement accomplished between the oscillating member 37, the ratch 38, and the blocking notch 35, an immobilization or winding of the cable-winding plate 12 can be thereby achieved via a reverse pull-out/release manipulation on the communication cable 13.

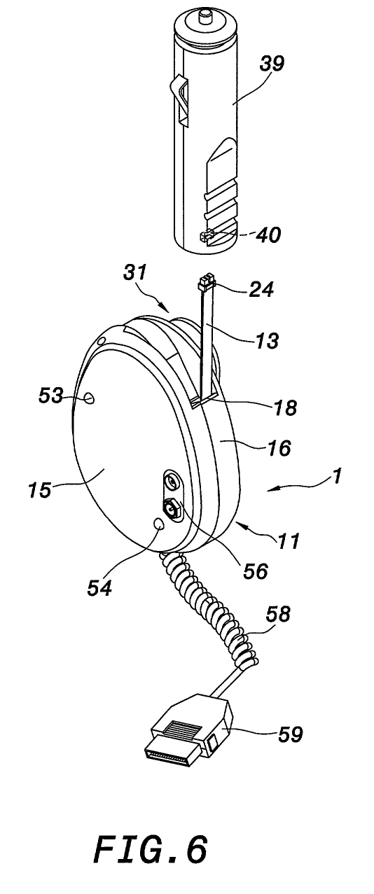

Referring to FIG. 6, the first connector 24 of the communication cable 13 may be further connected to a sixth connector 39 of another type that can, for example, accommodate an internal power recharge terminal of automobile. A seventh connector 40 is arranged within the sixth connector 39 in a manner that the sixth connector 39 can electrically connect the first connector 24 by simple engagement. The sixth connector hence can removably connect the communication cable 13 via simple engagement with the first connector 24.

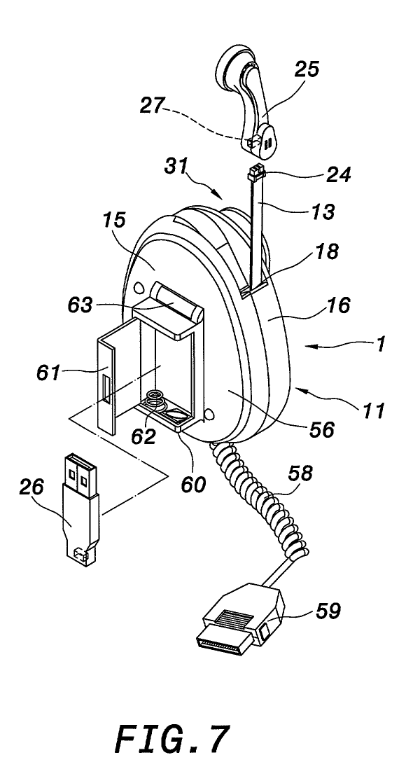

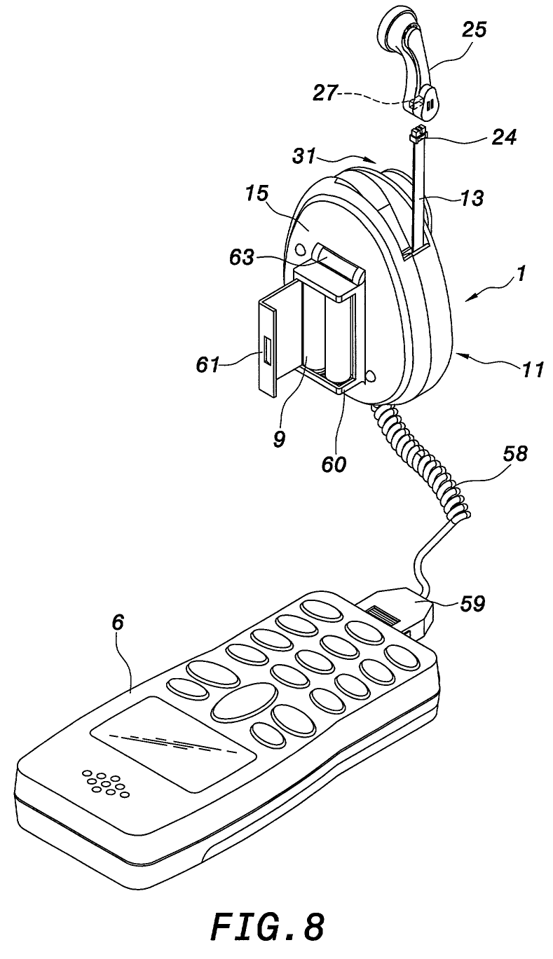

Referring to FIG. 7 and FIG. 8, the invention may be further provided with a battery case 60 externally mounted onto the outer case 11. A liftable cover 61 is mounted to the battery case 60. The battery case 60 is provided with a plurality of conductive elements 62 that electrically connect the circuit board 51. As shown in FIG. 8, conventional dry battery 9 can be received in the battery case 60 to supply the power recharge unit 5 with adequate power for recharging the portable electrical device 6. When no recharge is effectuated, the battery case 60 can be used as placement case for receiving, for example, the fifth connector 26 and/or other elements, as shown in FIG. 7. In addition, an indicator lamp 63, externally exposed out of the outer case 11, can be further connected onto the circuit board 51. The indicator lamp 63 can be used as illumination and/or warning lamp.

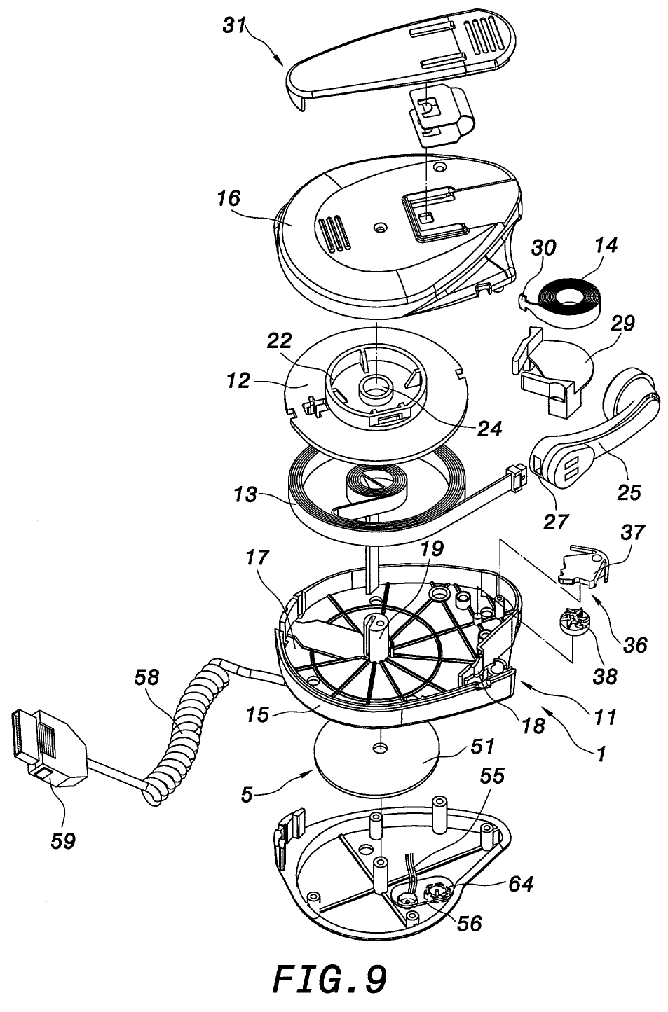

Referring to FIG. 9, the power recharge unit 5, according to another example, may be placed outside the outer case 11 and within the cable-receiving structure 1. A cover plank 64 hence fixedly secures and covers the power recharge unit 5 by fastening with the outer case 11.

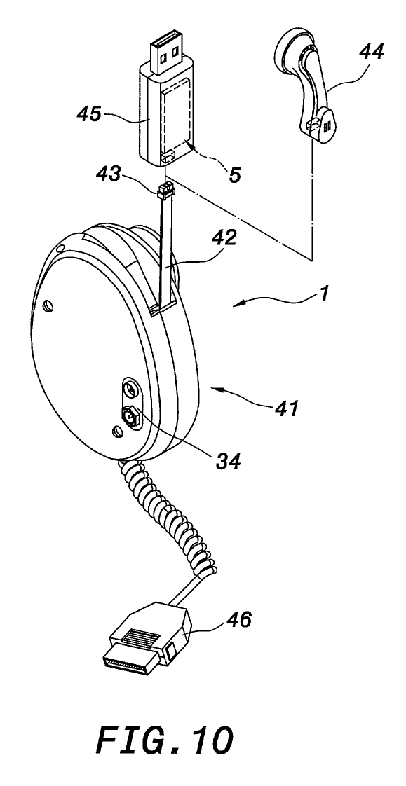

Referring to FIG. 10, a perspective view illustrates another variant example of the invention. Similar to the previous embodiments, the earphone cable-receiving device comprises a cable-receiving structure 1 and a power recharge unit 5. The cable-receiving structure 1 includes an outer case 41 in which a communication cable 42 is wound and retracted via resilient force. A first external terminal of the communication cable 42 is connected to a eighth connector 43 while a second external terminal of the communication cable 42 is connected to a tenth connector 46. The eighth connector 43 may removably connect either the earphone 44 or a ninth connector 45. One difference of the present example from the previous examples is that the power recharge unit 5 is incorporated in the ninth connector 45 into a single body. Via the eighth connector 45, the power recharge unit 5 can be therefore connected to a power source at one end (not shown) and the communication cable 13 at another end for recharging an external portable electrical device connected to the tenth connector 46.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An earphone cable-receiving device with power recharge function, comprising:
a cable-receiving structure including an outer case, a cable-winding plate, a s communication cable and a spiral spring connected to cable-winding plate, the spiral spring and the cable-winding plate received within the outer case, the communication cable having two ends and winding around the cable-winding plate, a first connector connected to one end of the communication cable, a earphone separately connected to the first connector; and
a power recharge unit installed onto the outer case and connected to the other end of the communication cable, a second connector further connected to the power recharge via a transmission cable.

2. The earphone cable-receiving device as claimed in claim 1, wherein the out case defines a cable-receiving cavity, a side of the cable-receiving cavity forms with a cable hole, a end of the communication cable projects the cable hole of the side of the cable-receiving, a center portion of inside of the cable-receiving cavity extends an shaft, and a central portion of the cable-winding plate forms a shaft hole thereof, the cable-winding plate received within the cable-receiving cavity, so that the shaft passes through the shaft hole of the cable-winding plate.

3. The earphone cable-receiving device as claimed in claim 2, wherein a cable-winding ring and a spring fastening seat are further respectively mounted on two opposite surfaces of the cable-winding plate, a fastener slot being further defined on the spring fastening seat to fasten an attachment end of the spiral spring positioned in the outer case via a support member, the communication cable being wound around the cable-winding ring and the shaft.

4. The earphone cable-receiving device as claimed in claim 1, wherein a clamp is further externally attached onto the outer case.

5. The earphone cable-receiving device as claimed in claim 1, wherein a battery case is further mounted onto the outer case, the battery case including a liftable cover member mounted thereon and a plurality of conductive elements that are electrically connected to the power recharge unit.

6. The earphone cable-receiving device as claimed in claim 1, wherein a blocking notch is further defined on the cable-winding plate and a back-and-forth controller device is arranged proximate to the cable-winding plate, the back-and-forth controller device including an oscillating member and a ratch that enable an immobilization or winding of the cable-winding plate via a reverse pull/release manipulation exerted on the communication cable.

7. The earphone cable-receiving device as claimed in claim 1, wherein the communication cable is a 4-wires cable having an internal terminal with two two-interlaced wires to connect the power recharge unit.

8. The earphone cable-receiving device as claimed in claim 1, wherein the earphone includes a third connector correspondingly connects to the first connector so that the earphone can be separately connected to the communication cable.

9. The earphone cable-receiving device as claimed in claim 1, wherein the fifth connector includes a fourth connector, the first connector can be further connected to a fourth connector of the fifth connector, so that the communication cable separately connects to the fifth connector.

10. The earphone cable-receiving device as claimed in claim 1, wherein the power recharge unit has a circuit board onto which is mounted an indicator lamp, a light hole being further defined through the outer case corresponding to the indicator lamp.

11. The earphone cable-receiving device as claimed in claim 1, wherein the battery-connecting seat is further electrically connected to the power recharge unit via a plurality of connecting wires, the battery-connecting seat being mounted onto the outer case.

12. The earphone cable-receiving device as claimed in claim 1, wherein the power recharge unit is respectively connected to the communication cable via a first transmission cable and to the second connector via a second transmission cable.

13. The earphone cable-receiving device as claimed in claim 1, wherein the power recharge unit is mounted within the outer case.

14. The earphone cable-receiving device as claimed in claim 1, wherein the power recharge unit is mounted in out of the outer case of the cable receiving structure.

15. The earphone cable-receiving device as claimed in claim 1, wherein a cover is further fixedly mounted onto the outer case to cover over the power recharge unit.

16. An earphone cable-receiving device with power recharge function, comprising:
a cable-receiving structure including an outer case, a communication cable received into out case and having two ends, one end of the communication cable having a eighth connector and the other end having a tenth connector, a ninth connector or earphone separately connected to the eighth connector; and
a power recharge unit being installed within the ninth connector connected to the communication cable.
